(19) United States
(12) Patent Application Publication
(10) Pub. No.: US 2007/0259326 A1
(43) Pub. Date: Nov. 8, 2007

(54) System and method for computer networked progressive learning

(76) Inventor: Vince Marco, Fort Collins, CO (US)

Correspondence Address: JAMES RAY & ASSOCIATES, 2640 PITCAIRN ROAD, MONROEVILLE, PA, 15146, US

(21) Appl. No.: 11/789,749

(22) Filed: Apr. 25, 2007

Related U.S. Application Data
(60) Provisional application No. 60/794,610, filed on Apr. 25, 2006.

(51) Int. Cl. G09B 3/00

(52) U.S. Cl. 434/350

(57) ABSTRACT

A method of learning includes developing a courseware including courseware content and developing at least one tool which has a predetermined relevant disclosure for aiding in learning the courseware content. Then, delivering the developed courseware developed and developed content learning tool to at least one student. Next, using, by the at least one student, the at least one content learning tool for learning the developed courseware content. The learning courseware content learning tools are delivered by way of a computer network.

### CROSS-REFERENCE TO RELATED APPLICATIONS

This application is related to and claims priority from U.S. Provisional Patent Application Ser. No. 60/794,610 filed on Apr. 25, 2006.

### FIELD OF THE INVENTION

The present invention relates, in general, to a computer aided instruction and, more particularly, this invention relates to system and method for computer networked progressive learning and, yet more particularly, the instant invention relates to system and method for computer networked progressive learning which employs content learning tools.

### BACKGROUND OF THE INVENTION

One problem that is continuously experienced in education is in that students learn most effectively not only by providing correct answers and solving the problems, but by failing while finding the correct answer and working through the problems. However, many educational and especially corporate training programs tend to guide students away from encountering and working through the problems. These programs typically follow the method of organizing and delivering program courseware, wherein the student receives the definition of the problem to be solved and then receives specific details on how to do it. This method is chosen for three main reasons. The first is time. Corporate training courses usually last 3-5 days with little time to let students fail, let alone encourage them to fail. The second is to avoid putting students in a position in which they feel bad due to failing or not knowing how to complete the exercises. The third is to avoid situations in which the instructor is unable to detect or respond to struggling students. That is why conventional training delivery method provides both the problem definition and detail set of instructions, sequences and/or steps on how to resolve the problem. Such prior art training delivery method does not allow the student to explore and try different approaches to resolve the problem.

Another problem is in that student's feedback is generally received at the end of the training period thus hindering the instructor from providing maximum assistance to struggling students. Students are reluctant to indicate they need help, and instructors often rely upon intuition to detect problems.

Yet another problem is in that training course designers often do not receive meaningfully feedback that enables them to effectively alter content and delivery of the training material. Often applying changes to courseware from student feedback gets bundled into new revisions of the courseware thus delaying improvement to the materials because due to cost.

Finally, as is well known, skills are developed through repetition. With the prior art learning systems, it is difficult to get students to repeat training in order to establish needed skills, particularly in the environment wherein student is able to broaden knowledge by being exposed to variations in delivery of the courseware material.

### SUMMARY OF THE INVENTION

According to one embodiment, the invention provides a method of learning. The method includes the step of developing a courseware including courseware content. Then developing at least one tool which has a predetermined relevant disclosure for aiding in learning the courseware content. Next, delivering the developed courseware developed and developed content learning tool to at least one student. Finally, using, by the at least one student, the at least one content learning tool for learning the developed courseware content.

According to another embodiment, the invention provides a computer system for use in learning of a courseware. The system includes at least one student workstation capable of providing at least one content learning tool for use by a student. There is provided an instructor workstation. A network server is provided for connecting the at least one student workstation to the instructor workstation, whereby the instructor is capable of monitoring usage of the at least one content learning tool by the student.

### OBJECTS OF THE INVENTION

It is, therefore, one of the primary objects of the present invention to provide a system for computer networked progressive learning.

Another object of the present invention is to provide a system for computer networked progressive learning which employs content learning tools.

Yet another object of the present invention is to provide a method for computer networked progressive learning wherein usage of content learning tools is employed for providing feedback to the courseware instructor.

A further object of the present invention is to provide a method for computer networked progressive learning wherein usage of content learning tools is employed for providing feedback to courseware designer.

Yet a further object of the present invention is to provide a method for computer networked progressive learning wherein usage of content learning tools is employed for monitoring student performance.

An additional object of the present invention is to provide a method for computer networked progressive learning wherein usage of content learning tools is employed for improving courseware design.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a block diagram illustrating progressive disclosure learning system of the present invention;

FIG. 2 is a block diagram illustrating design of a courseware of the present invention;

FIG. 3 is a block diagram illustrating the compute network for the progressive disclosure learning system of FIG. 1; and

FIG. 4 is a screen layout of the student workstation.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

The present invention overcomes the disadvantages of the existing courseware learning methods and systems by organizing the learning courseware in a manner that provides problem definition and expected success factors and further provides various multiple content learning tools enabling the student 2 to fail at the steps of an exercise while learning how to get past the problems that ultimately they are going to run into during actual use. The present invention provides for a higher level of learning as well as provides a framework for consistently building high quality learning courseware and improving such learning courseware through capturing contextual questions and feedback during student use.

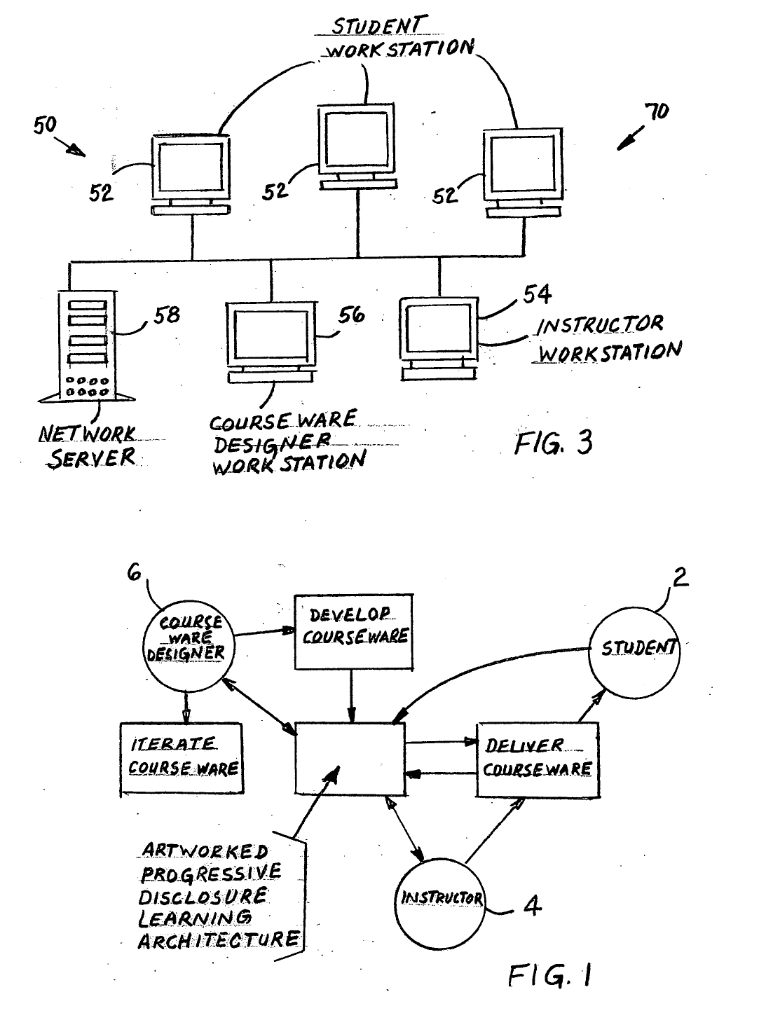

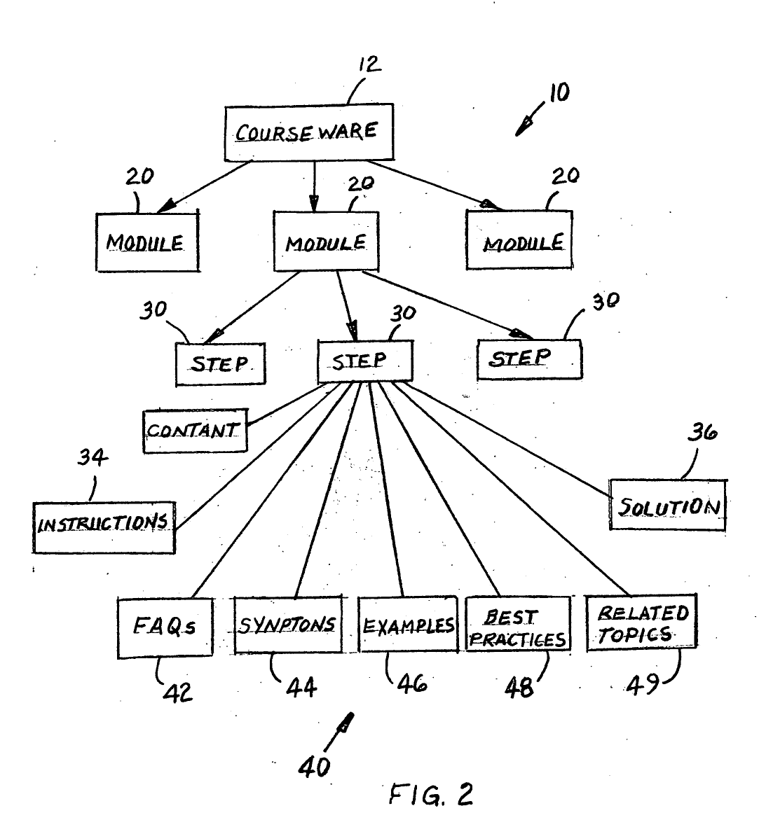

Now in reference to FIGS. 1-4, there is illustrated a progressive learning system, generally designated as 10, of the present invention. The system 10 contains an entire lifecycle system for developing, delivering, and improving learning courseware material and for applying modern learning theories through modern technologies. The method of learning begins with the step of developing courseware materials. This produces learning products which may be mixed and matched in various environments and which include but not limited to presentation, lab exercises, testing or any combination thereof.

The step developing courseware materials includes the step of organizing courseware 12 into at least one and preferably a plurality of learning modules 20. Each module 20 determines a content type that the student 2 will be exposed to during the learning process and a delivery execution of such content type. By way of examples only, a testing courseware 12 would likely consist of one or more modules 20 of a testing type. A lab courseware 12 would likely consist of one or more modules of a lab type and may include at least one testing module. A training courseware 12 may include presentation modules in addition to the testing and lab modules. In this way, learning products can be produced ranging from very specific to very comprehensive. These modules 20 are either arranged in sequential or random order and are just the foundation for the next level which enables the progressive disclosure of learning courseware 12.

The step of the developing courseware 12 further includes the step of organizing each learning module 20 into plurality of learning steps 30. These learning steps 30 provide incremental disclosure of the courseware content. The learning steps 30 may be either arranged in sequential or random order. It is within the scope of this invention that the student 2 must complete each learning step 30 in order to complete the learning module 20.

Each learning step 30 is provided with a content 32 and with a set of instructions 34 containing specific information needed by the student 2 to understand the nature of the content 32 to be learned. Instructions 34 present the task at hand for the current step 30, along with all needed information including the problem definition and expected outcome. In presentation and testing modules 20, the set of instructions 34 may include the main presentation/test for a current step 30, whereas in lab module 20, set of instructions 34 is focused upon presenting the minimal information needed to complete the current step 30. However, the set of instructions 34 does not include detail information on “how” to complete the step 30.

Each learning step 30 may be provided with an optional solution 36 containing detail information, such as guided sequence of tasks, that the student 2 can use to understand how to learn the content 32 and complete the step 30. In a conventional manner, the solution 36 discloses detailed guide of exactly what the student 2 must do to complete the particular learning step 30. The solution 36 includes but is not limited to a written and/or illustrated task by task content walkthrough, scripts, and/or narrated screen cast of the implementation of the step 30 or any combination of these steps 30. In the example of the presentation module 20, the solution 36 can contain a deeper presentation of the sub-topic for this step 30. In the example of a testing module 20, the solution 36 can be used for bonus questions.

Then, each learning step 30 is provided with at least one and, preferably, a plurality of various content learning tools, generally designated as 40, which are used by the student 2 in order to complete the step 30. Accordingly, the lifecycle continues with the step of developing such plurality of various content learning tools 40. Each of these content learning tools 40 focuses on a different type of information with a specific objective focused upon the student's learning and provides a predetermined disclosure relevant to learning content of the step 30. Furthermore, each content learning tool is characterized by a distinct level of disclosure. These content learning tools include but are not limited to frequently asked questions (FAQs) 42, symptoms 44, examples 46, best practices 48 and related topics 49.

FAQs 42 are captured from instructor 4 review and from actual student questions during delivery of the courseware. These questions are significantly general in nature, but are related to the particular step 30. Any number of FAQs can exist per each learning step 30.

Symptoms 44 are essentially specialized or more specific FAQs for the step 30 and facilitate development of the troubleshooting skills by the student 2. The symptoms 44 are intended to help student 2s to get back on track once they have hit a roadblock within the step 30. As with FAQS, any number of symptoms 44 can exist per step 30.

Examples 46 are similar tasks or sub-topics of the step 30 but are generally constructed to use different configuration or code. It will be appreciated that student 2s will understand through labels that examples 46 are not the same as solution 34 for their specific situation but will be similar to what they need to accomplish or learn. Any number of examples 36 can exist per step 30, thus varying the size and scope thereof.

Best practices 48 contain practices and methods that have produced outstanding results in a similar situation and that could be adapted for completing the step 30. For example, the best practices 48 may include formulas and procedures that have proven successful in practice. As is well known, in the information technology (IT) world, best practices 48 often refers to software development methodologies.

It is contemplated that related topics 49 would contain links to or excerpts from reference materials such as books, journals, technical presentations that are pertinent to the art of the step 30.

Next, the method of learning includes the step of delivering developed courseware 12 to at least one student 2.

The step of delivering developed courseware 12 is most advantageous to be achieved by way of a computer network and, more particularly, by way of a software application or web browser interface. The form, depth and breadth of the content learning tools 40 of the present invention are only constrained by the software and skill level of a courseware designer 6. A content learning tool 40 may be based on any one type of content including but not limited HTML, images, sounds, motion video, PDF, or any pluggable type, such as flash and shockwave.

Furthermore, the above method contemplates use of the progressive disclosure in both a live instruction and a virtual classroom environment. In fact, it has been found that the content learning tools 40 enabled by the progressive disclosure are essential for producing effective learning courseware 12 in a virtual classroom or web-based training environment.

The present invention contemplates combining computer based development and delivery of the learning courseware with web forums and/or instant messaging to provide both student and instructor tools for optimizing the virtual classroom environment.

Alternatively, the progressive disclosure of the learning courseware 12 may also be delivered via a printed or electronic document. This is accomplished by sequentially printing instructions 34, solutions 36, FAQs 42, symptoms 44, examples 46, best practices 48 and related topics 49 within the one document, and allowing the student 2 to only visit the pages they need during execution by means of navigation dividers (tabs) within each step 30. Although, less desirable than the computer based application, the printed avenue preserves the progressive disclosure of the learning content tools 40, thus allowing the student 2 to control how much challenge he or she wish to take on during the learning process.

Finally, the method of learning includes the step of using by the at least one student 2 the at least one content learning tool 40 for completing steps 30 and modules 20 and thus learning courseware 12.

The content learning tools 40 may be available to the student 2 in a manner that enables the student 2 to choose a single content learning tool or combination of content learning tools, that they need during each step 30 as well as a specific order of using them.

The present invention also contemplates that the access to these content learning tools 40 is provided in a predetermined order wherein the level of detail information is presented as a progressive disclosure or a disclosure wherein the supporting information is disclosed in a manner of progressively increasing completeness of the disclosure relative to the step 30. In the presently preferred embodiment of the invention, such predetermined order includes FAQs 42, symptoms 44, and examples 46. Best practices 48 and related topics 49 are presently contemplated as related but optional content learning tools. It is further contemplated that the student 2 may navigate to any of the content learning tools 40 for the current step 30, however, the content learning tools 40 are organized in the given order from least disclosing to most disclosing for the given step. Generally, the solution for each step 30 is not made available until the previous content learning tools have been visited. For example, the student 2 may not be able to use the solution 36 without first visiting the FAQs 42.

It will be appreciated that such method of organizing and delivering learning courseware 12 encourages student 2 to use content learning tools 40 during the learning process and further encourages him or her to try different approaches to learn new material or to solve the problem without fear of irreparable failure as these content learning tools 40 emphasize the power and flexibility of the progressive disclosure process.

Advantageously, the progressive disclosure of learning content tools 40 facilitates analysis, in a statistical manner, of the student 2 performance. Thus, the method of learning may include an additional step of determining performance level of the at least one student 2. The step of determining performance level of the at least one student 2 includes the step of tracking usage of the at least one content learning tool 40 by the at least one student 2. For example, the tracking software may capture each access to a specific content learning tool and discriminate student's knowledge or skill level based on established parameters of subject matter proficiency. Next, the tracking software may further capture the duration of time that the student 2 spends within each content learning tool in order to learn subject matter.

The method of learning then includes the step of analyzing the tracked usage of the at least one content learning tool 40 by the at least one student 2. Next, the captured usage of the content learning tools 30 and optionally the captured duration of time are compared to a predetermined criteria enabling assessment of the skill proficiency of the student 2 in the learning content 32. By way of an example only, a student 2 who completed the courseware 12 by using only one of the FAQs 42, symptoms 44, and examples 46 would be considered as subject matter expert, particularly if such student 2 needed such one content learning tool 40 only to complete a portion of all steps 30 or modules 20. Oppositely, the student 2 who used combination of content learning tools 40 to complete steps 30 would be considered as a person having a novice or entry level skill or otherwise indicative of a person who has a lesser understanding of the subject matter. It would be appreciated that a greater percentage of students, perhaps except for a few selected ones, will require the use of the content learning tools.

The method of learning may include the step of monitoring, by the instructor 4, performance of the at least one student 2. Similarly, to the step of measuring student 2 performance, the step of monitoring student 2 performance includes the steps of tracking usage of the at least one content learning tool by the at least one student 2 and comparing this tracked usage to predetermined criteria.

The method may also include the step of capturing student 2 feedback in the form of a question or a statement. Furthermore, the present invention enables such feedback to be provided anonymously relative to other students, so the student 2 who is providing feedback is not burden by the worry of being ridiculed by other students. The instructor 4 is capable to monitor student 2 performance based on the received feedback and address the question raised by one student 2 to the entire class if desired. The feedback may also be provided anonymously to the instructor 4, enabling the student 2 to ask questions that may be considered as not very intelligent questions. The feedback, which is captured at an incredibly high level in both instantaneous and recorded formats, enables the instructor 4 to obtain real-time information on the progress of each student 2, as well as to collect questions and feedback within the context of where the student 2 is at (and has been) within their learning session. This is useful both to instructor 4 available in a live or virtual classroom environment, as well as to instructor 4 providing support to individual learner staking an online tutorial outside of the classroom environment. The feedback may be also employed to identify patterns of student 2 behavior based upon pattern of using the content learning tools 40 which can be probed before the start of learning session to either better assign an instructor 4 with related knowledge or offer suggestions to students in the related courseware 12.

The method further includes the step of analyzing captured data of using content learning tools 40 and providing instructor 4 with the results of this analysis. The captured information and analysis are organized in accordance with a predetermined logic and presented to the instructor 4 in real time manner enabling the instructor 4 to address specific questions or somewhat alter the delivery of the learning courseware 12. For example, when the instructor 4 observes that the majority of the students use the entire range of the content learning tools 40 to learn content 32 within the module 20 or the step 30 and exceed the allowed time, indicating that the student 2s are struggling, the instructor 4 may terminate the session prior to its completion and move to the next module 20 or step 30 in order to keep pace with the entire courseware offering or the instructor 4 may choose to pause the module 20 or the step 30 and devote additional time to explain the subject matter. Thus, the instructor 4 in both a live and virtual classroom environment is able to efficiently and effectively monitor performance of the student 2, adjust delivery of the courseware 12 and respond to student 2 even before he or she decides to ask a question. It will be appreciated that with the method of learning of the present invention, instructor 4 will not have to solely depend on student 2 initiative and their own intuition and observatory skills in the classroom to detect when student 2 is struggling with courseware 12.

The software can also track content types that each student 2 use in order to identify and prioritize which content areas and content learning tools 40 get the most traffic and are used in which situations.

The method of learning may include the step of improving design of the learning courseware 12. The step of improving design of the learning courseware 12 includes the step of forwarding the captured feedback information to the designer 6 of the learning courseware 12. Preferably, the captured feedback information is forwarded in a real time manner. Thus, courseware designer 6 receives every question and feedback within the module 20 and step 30 in which it was asked. In response to receiving captured feedback, the courseware designer 6 evaluates the feedback and then modifies the respective modules 20 or steps 30 of the learning courseware 12. It is within the scope of the present invention for the courseware designer 6 to receive captured feedback which is identical to the feedback received by the instructor 4. It will be appreciated that a statistical analysis can be employed to analyze the captured feedback and provide the courseware designer 6 with the results of such analysis. Statistics may be averaged for a particular classroom and accumulated for delivery of each courseware 12 to assist the courseware designer 6 in modification of each courseware 12 for maximum effectiveness, as well as in modification of each courseware 12 based on the needs of a specific group of students. The present invention contemplates that the analysis of the captured feedback is both identical and distinct to the analysis received by the instructor 4. This feedback and the analysis thereof result in continuous and unmatched improvement in the quality and correctness of the courseware 12 and enable the courseware designer 6 to modify at least one of the learning content 32 and at least one content learning tool 40. For example, the courseware designer 6 may develop a brand new module 20 or a step 30. Or, the courseware designer 6 may be compelled to add new questions to the FAQs 42, expand symptoms 44, or introduce new examples 46 in order to provide additional information that can be used by the at least one student 2.

It will be appreciated that employment of content learning tools 40, capturing and analyzing usage thereof and capturing and analyzing feedback from the student 2 facilitates rapid iteration of the learning courseware 12. Therefore, the courseware 12 is continuously improved in content and value with each delivery to student 2 through live instruction, virtual classroom, and individual tutorials, and connect instructor 4s to student 2 for all delivery styles. It will be apparent to those skilled in the art that additional types of the content learning tools may be created during this iterative process to better suit needs of the student 2.

The present invention contemplates that growth and improvement of the learning courseware 12 through additions is managed independently from the enhancements to the courseware 12 or the content learning tools 40. This simplifies the change process as well as enables use of a separate work flow processes for changes versus additions. Quality assurance can be focused upon each type to enable high quality level thereof.

Consequently, the courseware designer 6 may not be burdened with a requirement for an intensive research and design to incorporate all that is known into the content 32 and/or content learning tools 40. Only one of the learning tools 40 may be available during the initial delivery of the learning courseware 12 to the general public. Or, baseline content may be established during trials. The additional content learning tools may be added with each subsequent delivery.

Thus, the additional benefit of the step of improving design of the learning courseware 12 is in that subsequent delivery of the learning courseware 12 includes improved and varying content of the courseware 12 and content learning tools 40.

The progressive disclosure of the content learning tools 40 is designed to focus specifically on the details such as when and how to present a specific content 32 to student 2, while remaining applicable to nearly any courseware material. When combined with computer-based delivery, it is going to provide more value to computer-centric training, and can be effectively combined with computer-based training (CBT). However, this process is very useful for non-computer centric topics and enables both the live instruction and virtual classroom instruction to benefit from establishing organized information streams in our training classrooms.

As has been described supra, the progressive disclosure of the learning courseware 12 is particularly advantageous in a computer based and, more specifically, a computer network based environment. Therefore, as best shown in FIG. 3, the progressive learning system 10 includes a computer network, generally designated as 50, which generally provides a plurality of student workstations 52, an instructor workstation 54 and a courseware designer workstation 56 which are connected therebetween by way of a network server 58. In some instances, the instructor workstation 54 and network server 58 may be combined, resulting in an environment in which the instructor workstation 54 serves all dependent functions needed by student workstations 58.

It will be appreciated that with the employment of the computer based and more specifically, a computer network based, learning involving use of software applications installed in computers, the student 2 is, in effect, trained by the computer. Thus, the student 2, if working alone, can set his or her own speed of learning. As such, the student 2 that is a quick learner can forge ahead at a pace that an average student 2 would not be able to handle. On the other hand, for those that take a little more time than the average student 2 to process and learn new information, they can go at their own stride, not fall behind and not keep any other students behind schedule.

The progressive disclosure organization challenges the student 2 with “how” to accomplish each step, pulling in the instructor 4 more frequently. This encourages the increase of instructor 4 value both in a live instruction or virtual classroom environment.

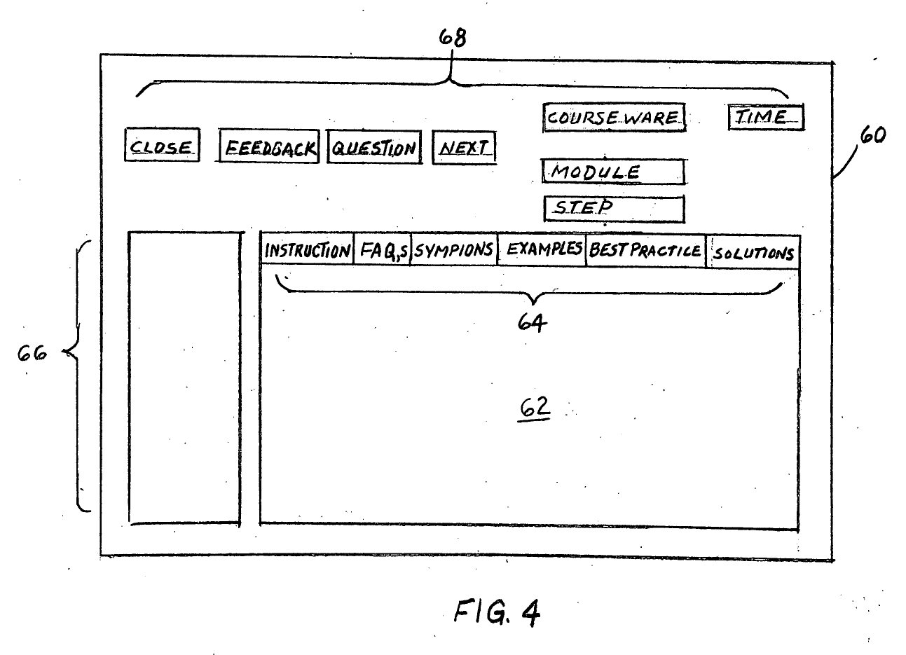

The present invention contemplates that the layout of the screen 60 on the student workstation 52 may be of the design shown in FIG. 4, wherein the screen layout 60 contains a main working area 62 for use by student 2, a plurality of tool bars 64 which are positioned above the working area 62 for directing students to content learning tools 40. Additionally, the tool bars 64 may be organized as a menu 66 which is positioned adjacent one side of the working area 62. Additional tool bars 68 are usable by the student 2 to provide feedback or submit a question as well as to choose a particular courseware 12, module 20 and the step 30.

It is contemplated that each of the screen layouts on the instructor 4 workstation 54 and the courseware designer 6 workstation 56 will be adapted to display feedback, questions, elapsed time, and other captured information as well as presenting analysis of the captured information.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A method of learning, comprising the steps of:
(a) developing a courseware including courseware content;
(b) developing at least one tool which has a predetermined relevant disclosure for aiding in learning said courseware content;
(c) delivering said courseware developed in step (a) and said at least one content learning tool developed in step (b) to at least one student; and
(d) using, by said at least one student, said at least one content learning tool for learning said courseware content delivered in step (c).

2. The method, according to claim 1, wherein the step of developing said courseware includes the step of organizing said courseware content into a plurality of content modules.

3. The method, according to claim 2, wherein the step of organizing said courseware content into said plurality of content modules includes the steps of organizing each module into a plurality of content steps and providing said at least one content learning tool for each content step.

4. The method, according to claim 1, wherein said method includes an additional step of determining performance level of the at least one student.

5. The method, according to claim 4, wherein the step of determining performance level of the at least one student includes the steps of:
(a) tracking usage of said at least one content learning tool by said at least one student in step (d);
(b) analyzing said tracked usage of said at least one content learning tool by said at least one student;
(c) comparing said analyzed tracked usage to preselected criteria.

6. The method, according to claim 1, wherein said method includes the step of monitoring performance of the at least one student.

7. The method, according to claim 6, wherein the step of monitoring performance of the at least one student includes the steps of:
(a) tracking usage of said at least one content learning tool by said at least one student; and
(b) comparing said tracked usage of said at least one content learning tool by said at least one student to predetermined criteria.

8. The method, according to claim 1, wherein said method includes an additional step of improving at least one of said courseware content and said at least one content learning tool.

9. The method, according to claim 8, wherein the step of improving at least one of said courseware content and said at least one content learning tool includes the steps of:
(a) tracking usage of said at least one content learning tool by said at least one student in step (d);
(b) analyzing said tracked usage of said at least one content learning tool by said at least one student; and
(c) modifying said at least one of said courseware content and said at least one content learning tool based on a results of said analyzed tracked usage.

10. The method, according to claim 8, wherein the step of improving at least one of said courseware content and said at least one content learning tool is achieved in a real time manner.

11. The method, according to claim 1, wherein said at least one content learning tool is selected from the group consisting of frequently asked questions, symptoms, examples, best practices, and related topics.

12. The method, according to claim 1, wherein said methods includes the step of providing plurality of content learning tools each characterized by a distinct level of disclosure relative to said courseware content and the step of using said plurality of content learning tools in a predetermined order.

13. The method, according to claim 12, wherein said predetermined order contains progressively increasing completeness of said relative disclosure.

14. The method, according to claim 1, wherein said method is provided by at least one of a computer network and printed material.

15. A computer system for use in learning of a courseware, said system comprising:
(a) at least one student workstation capable of providing at least one content learning tool for use by a student;
(b) an instructor workstation; and
(c) a network server for connecting said at least one student workstation to said instructor workstation, whereby said instructor is capable of monitoring usage of said at least one content learning tool by said student.

16. The computer system, according to claim 15, wherein said system further includes a courseware designer workstation which is connected to said server.
